(19) United States
(12) Patent Application Publication
(10) Pub. No.: US 2021/0288786 A1
(43) Pub. Date: Sep. 16, 2021

(54) Smart Security

(71) Applicants: Frank Nemirofsky, Alamo, CA (US); Ronald Miller, Farmington Hills, MI (US)

(72) Inventors: Frank Nemirofsky, Alamo, CA (US); Ronald Miller, Farmington Hills, MI (US)

(21) Appl. No.: 16/817,871

(22) Filed: Mar. 13, 2020

(51) Int. Cl. H04L 9/00; H04L 9/06; H04L 9/32; H04L 9/08; H04L 29/08

(52) U.S. Cl. CPC H04L 9/007; H04L 9/0643; H04L 67/306; H04L 9/0825; H04L 9/3247

(57) ABSTRACT

A system and method comprising a processor configured with an application interface to create hashed and digital signatures for a plurality of users and to assign each hashed and digital signature to a user as a unique public-private key. The system further includes a memory configured to store smart data profile with each user, and the smart data profile is used to monitor communication and consumption of data, information, content, or communication with super-nodes. The network interface is configured to use the public-private key to receive and send data to securely communicate peer-to-peer, peer-to-super-node, or peer-to-server using network or gossip protocols.

### TECHNICAL FIELD

The present disclosure relates generally to a system and method for an enhanced security system and more specifically using a security embedded code to create an advanced system and method for authenticating a user or group of users.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1A illustrates a Representation of the Smart Security Architecture;

FIG. 1B illustrates a Representation of the Smart Security Encryption & Digital Signature System;

FIG. 2 illustrates the Hyperspatial Device Specific Content & Communication;

FIG. 3 illustrates the Smart Security Content Delivery Services and Networks;

FIG. 4 illustrates the Human-Centric Digital Data & Information Content Curation Communications (C3) Dimensionality; and

FIG. 5 illustrates the Smart Security Server.

### DETAILED DESCRIPTION

Security has become a major concern over the last few years as hackers have penetrated many IT infrastructure of governments and enterprises with increasing frequency and sophistication. The growth of mobile and IoT devices similarly increases the exposure of cybersecurity threats for all individuals and users, including enterprises, of all content and communication networks. It is estimated that over $650 Billion USD will be spent on cybersecurity initiatives to protect PCs ($386 Billion), mobile devices ($113 Billion), and IoT devices ($172 Billion) between 2015-2020. The top 5 areas of attacks are Zero-Day, Cloud-Data Leakage, Mobile Malware, Targeted Attacks, and SQL Injection. The corresponding area of protection is Network Defenses, Endpoint and Mobile Device Protection, Data in Motion Defenses, Data at Rest Defenses, and Analysis & Correlation Tools.

This invention, referenced as SmartSecruity, embodies a novel and new technology to secure individuals, enterprises, data, and networks. Leveraging SmartPlatform (U.S. Application No. 62/518,189 filed on Jun. 12, 2017, entitled SmartPlatform, which is hereby incorporated by reference), and SmartData (U.S. application No. 62/367,772 on Jul. 28, 2016 entitled SmartData, is hereby incorporated by reference), SmartSecurity provides a uniquely safe, reliable, and secure authentication and digital signature process for each user, application, and cyber-physical-systems. Subsequently, SmartSecruity significantly reduces major attaches and provides an enhanced protection for Network Defenses, Endpoint and Mobile Device Protection, Data in Motion Defenses, Data at Rest Defenses, and Analysis & Correlation Tools.

SmartPlatform is an electronic cognitive content communications networks that serves substantially all content to substantially all people in the mass media audience from providers to end users and all points in between, of data, information, and networking. SmartData, as disclosed in U.S. application No. 62/367,772 on Jul. 28, 2016 entitled SmartData, is hereby incorporated by reference, is a system and method for determining useful (valued) and contextually relevant data, components of data, statistics, facts, figures, numbers, documented information, observations from real time and or videoed and reviewed after the fact that can be derived from singular or in combination from any form of live or recorded video, audio, audio-video, sensors developed for a myriad of uses, coupled with one or more of GPS, Compass, accelerometer, including but not limited to partial and entire findings, conclusions, of networked and or individual devices, instruments, devices, databases, analytics, visualization and processing architecture. SmartData determines which data, captures all data, and analyzing all varied data sources to determine appropriate information from the data. Reducing data and model complexity, and simplifying analyses provides unique and meaningful insights into many of the Big Data ecosystems problems faced by individual users, corporate, academic, vocational and avocational and all other organizations, groups and all other group including governmental bodies, agencies, groups etc. today. SmartData aims to resolve non-linear real world problems from received and captured data.

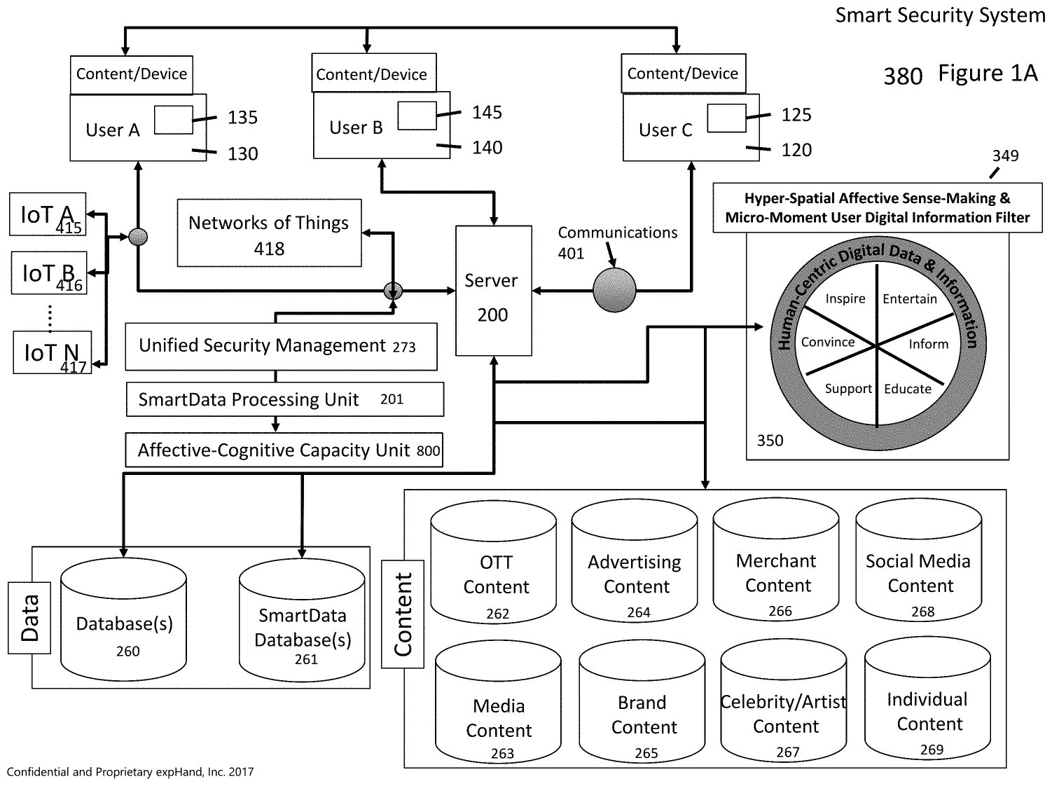

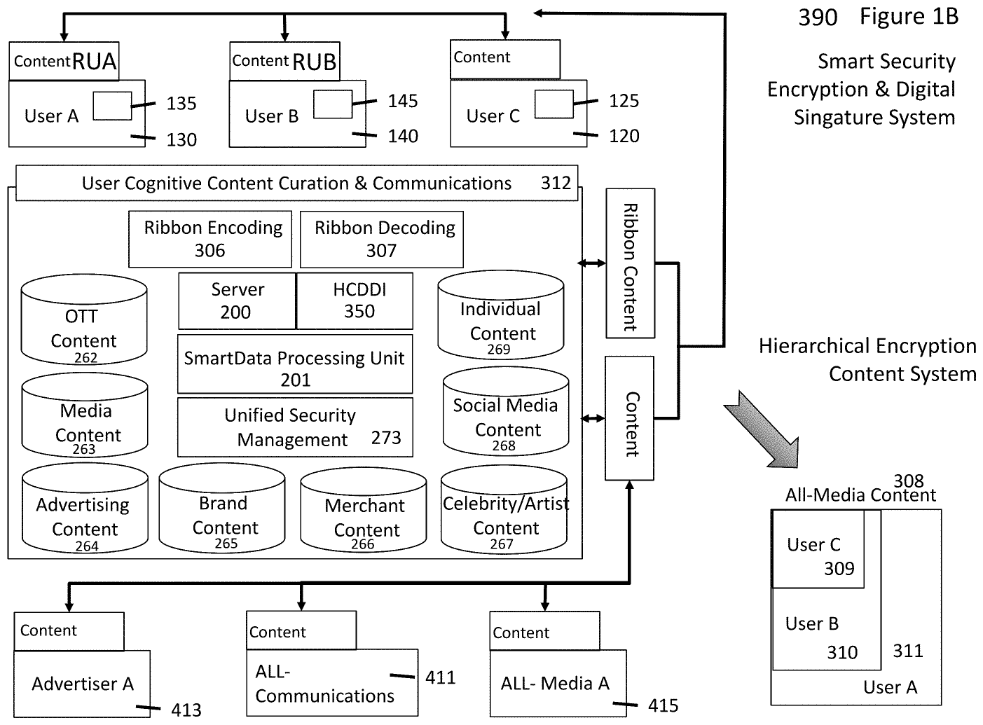

FIG. 1 380 shows a representative architecture for the Smart Platform that integrates the HCDDI 350 and an Affective Platform 100. Users are distributed throughout a hybrid network and appear/disappear based upon their associated activities, and can process, share, cache, store, and forward personally- or group-secured content with digital key security encryption, enabled by a Unified Security Management 273 process and Ribbon Encoding/Decoding 306, 307. User A 130, with a smart device 135, may contain all-media content (e.g., video, audio, images, print etc.) that can be partial or complete in nature and securely concealed or embedded using an individual or shared embedded code. Users who do not possess embedded code security access or the proper digital signatures will have limited access to content. Users can be any arbitrary process, requiring data, information, content or connectivity supporting a goal or objective within the Smart Platform. User A 130. User B 140, and User C 120, with process, components, and things ranging from smart devices 135, 145, 125 and IoT 415-417 devices to the Networks of Things 418. Each user can be equally represented as individuals, family, groups, organizations, enterprises, and governments system 380. Users communicate through various server applications, as represented by Server 200, and with the Smart Platform Content Delivery System (not shown). The SmartData Processing Unit (disclosed in U.S. No. 62/367,772), in concert with contextual and predictive activity modeling, data sources 260, 261, and the Affective Sense-Making & Micro-Moment Digital Information (ASMDI) Filter 349, render applicably filtered content 262-269 to each user, or from each user, or any combination there within, as determined through an asynchronous or synchronous network and communication architecture.

To further exemplify the Smart Platform, imagine User A 130 is a celebrity or artist. User A 130 embeds a Ribbon or an embedded code into their content 267-269 for distribution for their fan club members (i.e., group) can consume and unlock embedded content using their personal and/or group Ribbons (security keys). User A forms a participatory commerce (PC) chain (Participatory Commerce, U.S. Ser. 62/411,666, filed on Oct. 23, 2016 and is hereby incorporated by reference) with Brands, Advertisers, Merchants, and Media, resulting in embedded content from PC partners, provided the user's HCDDI and affective dimensional space are within the hyperspatial user dimensions. This content may be in the form of personal messages, video-audio clips of a new songs, discount and merchandise offers that can be redeemed nationally (AdPlexing, U.S. Ser. No. 62/268,003, which is hereby incorporated by reference) or locally (LocalPlexing, U.S. Ser. No. 62/358,538, which is hereby incorporated by reference), including behind-the-scenes information, content or access etc. User B 140 may be any individual or a group with a shared ribbon or shared embedded code, enabling the decoding and utility of hierarchical embedded content whereby the hierarchy is determined by the Ribbon or embedded code access security and authorization. Although User B has access to the concealed and embedded content, the ASMDI Filter 349 determines the level and type of content decoding. User B 130 may need to be Inspire 351 more than the other affective HCDDI components [Convince 352. Support 353, Educate 354. Inform 355, and Entertain 356], resulting in a “message” of encouragement from User A 130. The level of inspiration is determined from several affective sources including IoT 415-417 and the Network of Things 418 disclosed in Networks of Things. U.S. Ser. No. 62/358,546, which is hereby incorporated by reference, components, things, and processing. Real-time analyses from the SmartData Processing Unit 201, including AI, Machine and Deep Learning, determine the appropriate content 262-269 for each user during all activities, events, and situations. Contextual and hyperspatial conditions influence the nature and level of information (all-media) encoding/decoding and user content rendering. This results in a truly self-aware and cognitive content curation and communication 312 using smart devices, hybrid networks, and the Smart Platform. Note that an electronic smart device 130, 140, 120 may be a smart-phone, tablet, laptop, wearable technology, television, electronic glasses, watch, embedded device, or other portable electronic device that incorporates sensors such as at least one of camera, microphone, accelerometer, GPS, or transmission capability via wireless telephone, Wi-Fi, Bluetooth, NFC, etc.

The system and method connects all devices. The devices may include anything within the internet of things, but also anything within the Network of Things. The devices may be smart phones, smart devices, laptops, computers, televisions, television boxes, smart boxes, wearable technology, embedded devices, electronic devises, tablet, electronic glasses, watch, embedded device, or other portable electronic device that incorporates sensors such as at least one of camera, microphone, accelerometer, GPS, or transmission capability via wireless telephone, Wi-Fi, Bluetooth, NFC, etc. The network of things deals with the interconnectivity of all hardware, but focuses on the self-forming networks of knowledge and sense-making, that are particular to an individual, group, organization, or institution. Since each network entity on the IoT possesses a processor and a communication mechanism, from RFIDs products to computers, each device can communicate with a Ribbon or unique identifier with different levels of complexity that defines the networks entity in relationship to the formed network. The formation of each network depends on the network structure and query that are dependent on Ribbon identifier or unique identifies, node structure of the network, and utility.

Also the Network of Things allows the use of embedded codes to link all kinds of things to the internet, to the individual, group, organization, and institution, to their needs, wants and desires, either now or in the future. The use of an embedded code within a printed publication, an embedded code within an advertisement, an embedded code within a radio broadcast, etc. may all be connected to the internet and tracked as the embedded code is read by different devices, which may or may not be autonomous in nature. The Network of Things is communication agnostic and operates on top of any communication network/system such as RFID, Zigbee, WiFi, and TCP/IP Internet based protocol, creating personalized networks, component of networks, and things.

The system and method includes content from multiple sources. FIG. 1 demonstrates some of the foundational elements comprising the Smart Platform, which offers interactive, personalized, and affective (emotional) content and networks that are ubiquitous, systematic, individualized that form dynamically (automatic or self-forming) or manually 400, that gather, analyze, subscribe, delivery, and share arbitrary content. The content type is determined based upon platform user's profiles, Ribbons (e.g., disclosed in, US Serial 2014/0303991, 2004/0117255), and SmartData (disclosed in U.S. No. 62/367,772), whereby the ubiquitous network communications utilizes People 302. Processes 303. Things 304 and Data 305, in conjunction with Server 200, to cognify content across User A 401. User B 402, Group A 403, Group B 404, Object A 405, Object B 406. Process A 407, Process B 408, AI Agent A 409, AI Agent B 410, Brand A 411, Brand B 412, Advertiser A 413, Media A 414 and more.

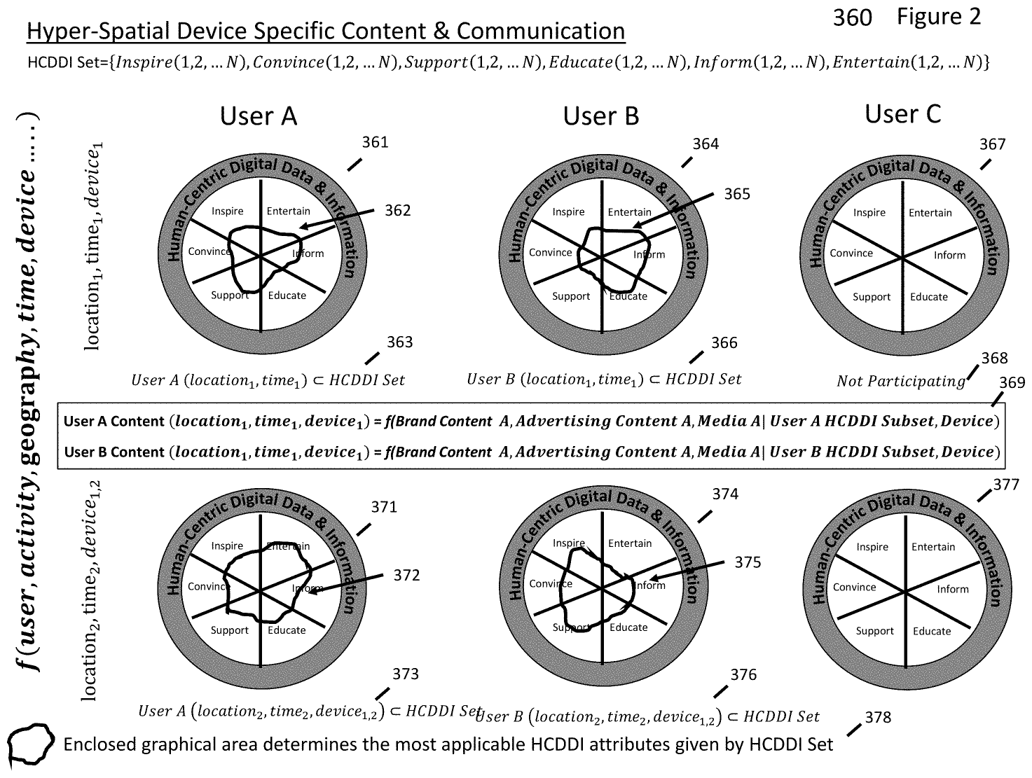

Cognitive curation and contextual delivery of consumable all media content requires not only the proper security and personalization, but a mechanism that can determine and predict the dynamic evolution of a user's personalization requirements. FIG. 2 360 describes the content selection process that is dependent on a user's need, as a function of context, activity, time, location and more. The multidimensional Human-Centric Digital Data & Information 350 user requirements are hyperspatial influenced and determined in part from previous experiences (preferences, opinions, moods, past content consumption), as well as real-time experiences and behaviours. As shown in FIG. 2. User A 130 has a unique HCDDI profile 361 that includes a subset of all content, across the HCDDI profile dimensions, including Inspire 351, Convince 352. Support 353, Educate 354. Inform 355, and Entertain 356. A bounding graphical surface shown in FIG. 2 360 displays the relative importance of each HCDDI 350 category for User A 130 and User B 140, as 362 and 365, respectively. Each user's HCDDI subset is unique and depends on an individual's goals, objectives, experiences. The hyperspatial dynamics can be seen by comparing User A 130 and User B 140 HCDDI subsets, as 362 and 365 that evolve to 372 and 375. The HCDDI subsets change ascribing a real-time cognitive user sensitivity for consumable content. This optimizes each user's experiences, and thereby empowers the user to achieve deterministic goals and objectives. The HCDDI user subsets represent a dynamical multidimensional parameter space that is solved for each user in real-time, employing parametric and non-parametric solutions, contained within the SmartData Processing Unit 201.

User A's and User B's content, as exemplified by equations 369 in FIG. 2 360, are functions of Brand A 411. Advertiser A 413, and Media A 414 content, given HCDDI user subset. Although equations 369 explicitly show a limited set of content providers, the architecture and methodology is extensible and supports an arbitrary group or set of content providers across all media, and may include but is not limited to OTT 262, Media Content 263, Advertising Content 264, Brand Content 265, Merchant Content 266, Celebrity/Artist Content 267, Social Media Content 268, Individual Content 269, and more. The Smart Platform transforms existing content engagement mechanism, systems and networks into Cognitive Content and Communications (C3) Networks & Processes.

An example of networked components, things, and devices includes users, groups, objects, processes, AI agents, brands, advertisers, and media channels. Each entity has goals, plans, strategies, and actions and may cooperatively (or non-cooperatively) engage any entity to accomplish a single or collective goal and objective. FIG. 1 380 shows 3 arbitrary users (e.g., individuals, family, groups, organizations, enterprises, and governments) participating on the Smart Platform in either a synchronous or asynchronous manner, which may cooperative or not cooperative. FIG. 2 360 demonstrates how cognitive content changes as a function of each user, their context, environment and personalized preferences. And in particular, how cooperative engagement leads to an optimization for all users as highlighted in the commerce chain of users, brands, advertisers, and media 369. Embedded content (i.e., content inside content), that is engineered specifically for each user, changes the landscape of content and communications 312, by providing specialized data and information to each user, or collection of users, that have the proper authorization to decode and view this content. This secure and non-invasive data, information, and content allows Brand A 411, Advertiser A 413, and Media A 414 to engage users with intelligent content tailored to user's needs, including discounts, offers, videos, experiential opportunities, enhancing communication and engagement.

User A 130, with smart device 135, has either no content, a partial representation, or a complete copy of content on their smart device, representing Individual Content (not shown). Similarly, User B 140 and User C 120 have smart devices and a representation of personalized content. Each user on the Smart Platform is provided a dynamic and personalized Ribbon. User A and User B are assigned Ribbons RUA and RUB, respectively. Alternative the Ribbons may be embedded codes. User C is a contributor to the network (e.g., anonymous sign-in) and shares content but has limited access without a Ribbon. Users communicate with Server 200 and/or between peers in order to manage their data, information, applications, and content during their daily activities and life events. Advertiser A, Brand A. and Media A distribute content whereby each one has content that is delivered separately or collectively to the Smart Platform, and then to users. Content is processed in real-time by the SmartData Processing Unit 201 and is stored, cached, forwarded, distributed and delivered to User A and User B with Ribbons RUA and RUB, respectively, and to User C without any Ribbon Encoding 306. Server 200 uses individualized HCDDI 350 subset specifications to determine the appropriate content filtering with recommendations determined by numerical methods employing AI, Machine Learning, and Deep Learning Neural Nets. Content 262-269, when offered, selected or served to users is encoded (content inside content), allowing for a Media Content overlay or hierarchy 308. Each user, although receiving the same content has access to a varied level of diverse embedded content. In this scenario, User C 120 receives generic content 309; however, User B 140 decodes more content 310, while User A 130, due to its user attributes, receives more content 311. The content ranges from videos, images, audio, and print to discounts from brands on selected purchases and more. Without a Ribbon or embedded code, User C 120 is not able to share and engage fully in the cognitive hybrid network.

The Ribbon is the user's network securitized content and communications key, which unlocks specialized data and information. The Ribbon Encoding 306 process supports arbitrary encoding of embedded or conceal information inside all media without increasing the payload of the content. Examples include hierarchical content embedding with arbitrary levels of encoding and encryption such as video inside video, with audio encoded with images such as discounts. The level of Decoding 307 is based upon the user's Ribbon and profile, including hyperspatial context. The Smart Platform Ribbon Encoding 306 and Decoding 307 are non-invasive and seamless using multi-level encrypted transform methods.

User A 130, with smart device 135, creates a mobile content delivery networks with its peers. User B 140 and User C 120. The nature of the shared information is defined by the personalized Ribbon and SmartData, as a shared key-value Ribbon pair that allows for either the unlocking or locking of embedded content inside content. Ribbon RUA (User A 130) and RUB (User B 140) share an encrypted content key, which enables peer-to-peer communication between both User A and User B, content sharing, and the unlocking of embedded content. Each Ribbon also provided for secure server content sharing. Both users share curated content based upon their individual and shared Ribbon, including a mesh topology between mobile. Super-Nodes, and static (Server 201-206) CDNs. If the desired content is not found among its peers, or Super-Nodes, then the CDN servers provide the necessary information. Depending upon the distribution of nodes, partial or complete information or content replication occurs within the mobile or static smart devices and servers. Human-Centric Digital Data & Information 350 is utilized with architecture described in FIG. 1 380, to determine the data, information, curated content and media content distribution. This information also allows for CDN Services to predict CDN services, pre-caching, and improving network quality of service (QoS). In all cases, Server 200 mediates each Smart Platform users and Cognitive Content Communications Networks & Processes.

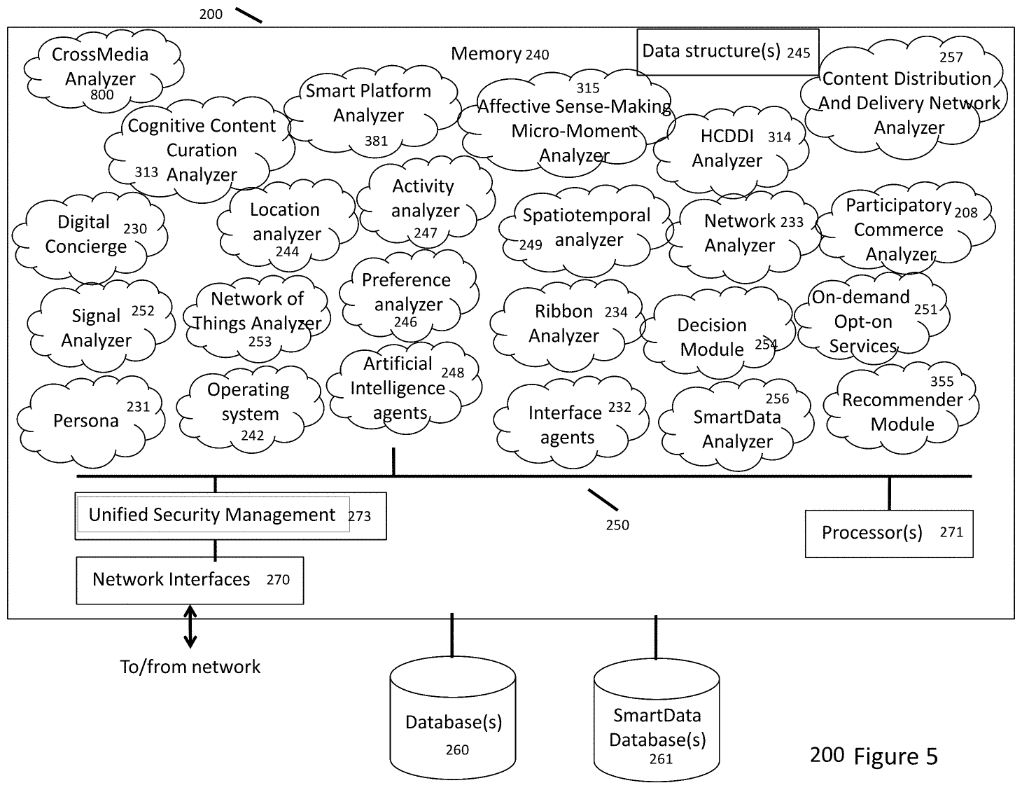

FIG. 5 shows a schematic block diagram of an example Server 200 that is used with one or more embodiments of this invention and described herein. Server 200 initiates the Smart Platform Analyzer 381, Cognitive Content Curation Analyzer 313, HCDDI Analyzer 314 and Content Distribution and Delivery Network Analyzer 257 as part of the Smart Platform's Cognitive Content and Communications Networks & Processes (this included manual, automatic and arbitrated services with synchronous and asynchronous information and dynamics) and manages the main processes and curates, delivers, distributes Ribbonized (security keys) content across hybrid networks. Several key components, as part of the Server 200 processes, facilitated cognitive content curation and communication, such as Activity Analyzer 247, Location Analyzer 244 and Spatiotemporal Analyzer 249 that work together to help determine the activity, context, location, time, including the behavioral and historical significance of the user's state as given by the SmartData Analyzer 256. Coupled with the Preference Analyzer 246 and Decision Module 254, the Recommender Module in concert with the HCDDI 314, Cognitive Content Curation 313, and the Content Distribution and Delivery Network 257 Analyzers, determines the most salient content including how to deliver the content through unique user Interface and Artificial Intelligence Agents 232. Participatory Commerce Analyzer 208 is used to determine the nature of a commerce chain whereby discounts, offers, and opportunities are offered to users. All communications are securitized by the Uniform Security Management 273 module and the Ribbon Analyzer 234, which provides dynamic cognitive curated content communications and distribution.

The server 200 may comprise one or more network interfaces 210 (e.g., wired, wireless, etc.), at least one processor 220, and a memory 240 interconnected by a system bus 250, as well as a power supply (e.g., battery, plug-in, etc.). Additionally, or in combination server 200 may be implemented in a distributed cloud system. The network interface(s) 210 contain the mechanical, electrical, and signaling circuitry for communicating with mobile/digital service provider 135, 145, 125 (FIG. 1) and/or any communication method or device that enables and supports (synchronous or asynchronous) Smart Platform users (e.g., smart device which can be a smart-phone, tablet, laptop, smart television, wearable technology, electronic glasses, watch, or other portable electronic device that incorporates sensors such as at least one of camera, microphone, GPS, or transmission capability via wireless telephone, Wi-Fi, Bluetooth, NFC, etc.). The network interfaces may be configured to transmit and/or receive data using a variety of different communication protocols. Note, further, that server 200 may have two different types of network connections 210, e.g., wireless and wired/physical connections, and that the view herein is merely for illustration.

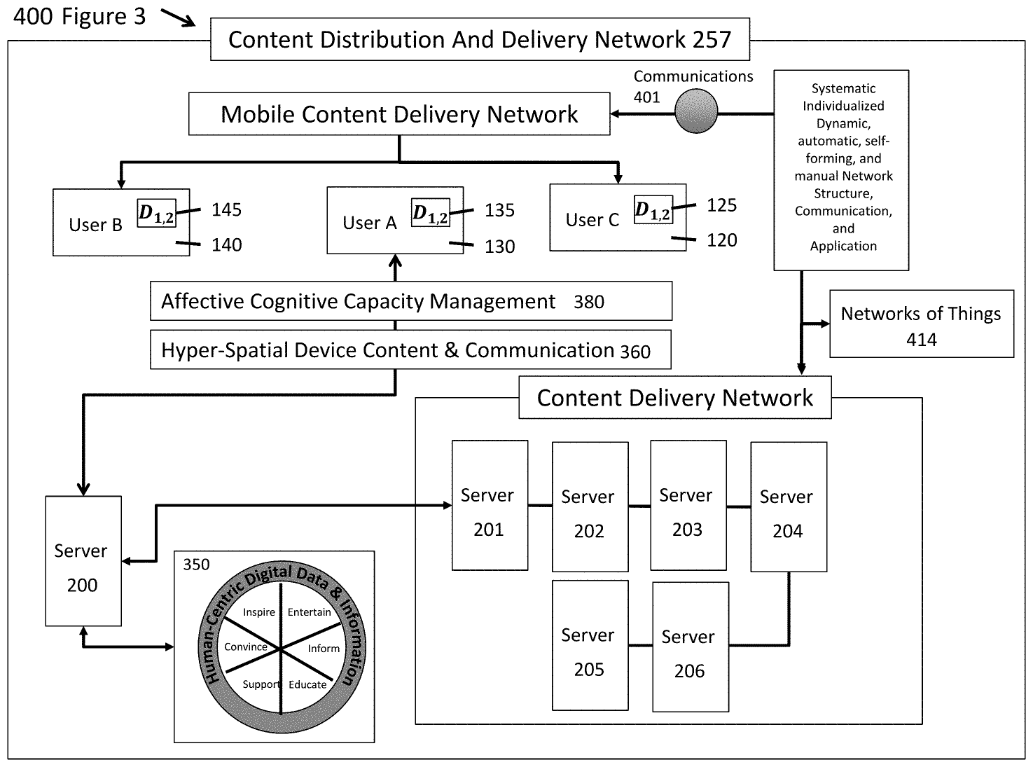

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate data structures. An operating system 242, portions of which are typically resident in memory 240 and executed by the processor, functionally organizes the server 200 by, inter alia, invoking operations in support of software processes and/or services executing on the device. These software processes and/or services may comprise a Signal Analyzer 252, Preference Analyzer 246, Location Analyzer 244, Activity Analyzer 247, Spatiotemporal Analyzer 249, Artificial Intelligence Agents 248, Ribbon Analyzer 234, Interface Agents 232, Network Analyzer 233, Brand Connector 231, and Digital Concierge 230, Network of Things Analyzer 253, Decision Module 254, Recommender Module 355, SmartData Analyzer 256, Content Distribution and Delivery Network 257, Market Basket Module 356, On-Demand Opt-on Service 251, Participatory Commerce Module 208, Smart Platform Analyzer 381, Cognitive Curation Analyzer 313, Human-Centric-Digital-Data & Information (HCDDI) Analyzer 314 that all play critical roles in interpreting and supporting manual, automatic and or arbitration processes as shown in FIGS. 1 380, FIG. 2 360, and as described herein. Note a centralized memory 240 is shown in FIG. 3, alternative embodiments provide for the process to be specifically operated within the network interfaces 210. Another alternative uses a plurality of stand-alone servers, with each server performing steps of a single or multiple processes. Signal Analyzer 252, Preference Analyzer 246, Location Analyzer 244, Activity Analyzer 247, Spatiotemporal Analyzer 249, Artificial Intelligence Agents 248, Ribbon Analyzer 234, Interface Agents 232, Network Analyzer 233, Brand Connector 231, and Digital Concierge 230, Network of Things 253, Decision Module 254, Recommender Module 355, SmartData Analyzer 256, Content Distribution and Delivery Network 257, Market Basket Module 356, On-Demand Opt-on Service 251, Participatory Commerce Module 208, Smart Platform Analyzer 381, Cognitive Curation Analyzer 313, Human-Centric-Digital-Data & Information (HCDDI) Analyzer 314, and Affective Sense-Making Micro-Moment Analyzer 315, all perform multiple analyses utilizing various techniques (AI, ML, Deep Learning, EM, GA, NN and others), however each analysis may be performed by a separate process. Each separate process may be performed by a single server or a combination of servers, that may or may not be distributed in the cloud.

Network Analyzer 233 plays a critical role in the Smart Platform architecture and manages the hybrid network communications. Combined with the Smart Platform Analyzer 381, Cognitive Curation Analyzer 313, HCDDI Analyzer 314, and the Affective Sense-Making Micro-Moment Analyzer 315, the Network Analyzer 233 facilitates the communication and delivery, distribution, caching of cognitive content with Ribbonized security, from the Ribbon Analyzer 234 and the Unified Security Management 273 system.

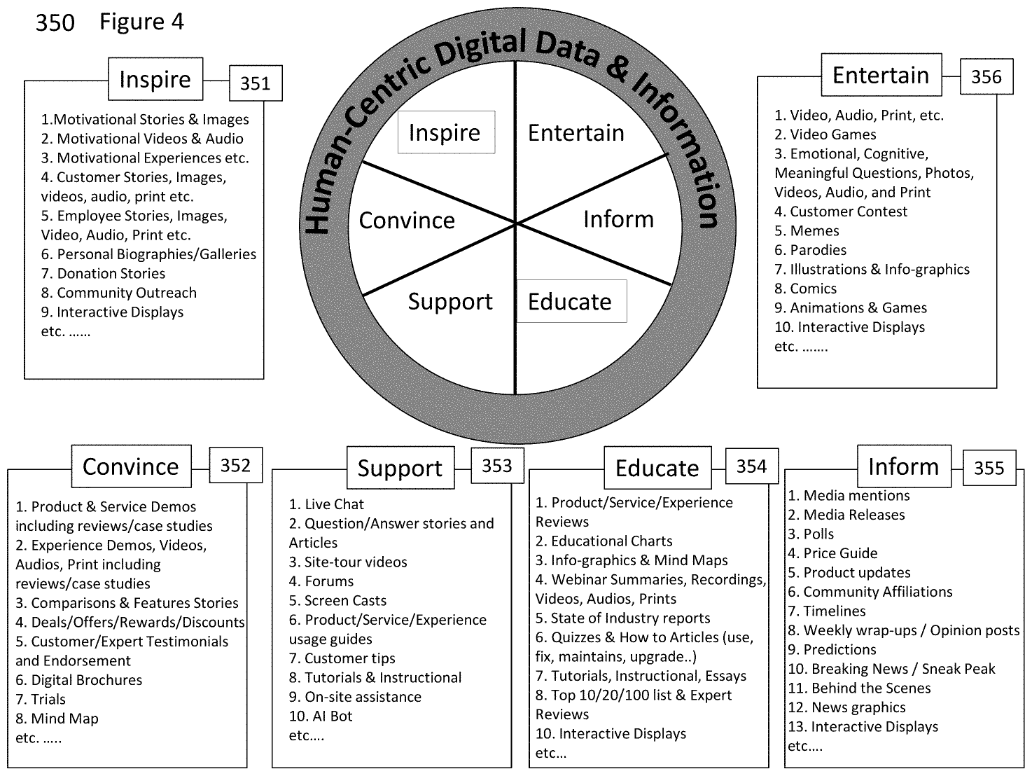

Content has a broad definition and simply is what the end-user derives value from and can refer to the data and information provided through a particular medium, the way in which the information is presented, as well as the added features included in the medium in which that information is delivered. The medium is the content channel through which content is delivered and affects how the end user perceives the content. With increases in connectivity, smart devices, and high-speed, high-bandwidth communications, content delivery and diversity are increasing exponentially. FIG. 4 350 shows the complexity and dimensionality of content delivery and consumption. Individuals are presently overloaded with digital noise from emails, social media, news as well as advertisers which produce over 5000 ad impressions per person per day. This overload is expected to increase as the IoT (Internet of Things) develops. Making sense of the information, from any arbitrary network infrastructure, is needed to facilitated the next generation of digital experiences that benefit the user personally thought out their life experiences, and may include applications such as Health and Wellness, Education, Marketing & Advertising, Financial Technologies (FinTech), Entertainment and more.

Data security refers to protective digital privacy measures that are applied to prevent unauthorized access to computers, databases and websites. Data security also protects data from corruption with examples of data security technologies include backups, data masking and data erasure. A key data security technology measure is encryption, where digital data, software/hardware, and hard drives are encrypted and therefore rendered unreadable to unauthorized users and hackers. One of the most commonly encountered methods of practicing data security is the use of authentication. With authentication, users must provide a password, code, biometric data, or some other form of data to verify identity before access to a system or data is granted. Data security is also very important for health care records, so health advocates and medical practitioners in the U.S. and other countries are working toward implementing electronic medical record (EMR) privacy by creating awareness about patient rights related to the release of data to laboratories, physicians, hospitals and other medical facilities.

Security is required and is constantly changing in order to thwart adversarial attaches. Some of the security areas are as follows: Application security is the use of software, hardware, and procedural methods to protect applications from external threats with countermeasures including application firewalls, encryption programs, patch management, and biometric authentication systems. Cloud security is the set of policies and technologies designed to protect data and infrastructure involved in a cloud computing environment. The top concerns that cloud security looks to address are identity and access management, and data privacy. Endpoint security is the part of network security that requires network devices nodes to meet certain security standards before they can connect to a secure network. Nodes devices include PCs, laptops, smartphones and tablets. Endpoint security also extends to equipment like point-of-sale (POS) terminals, bar code readers and IoT devices. Internet security—the protection of software applications, web browsers and virtual private networks (VPNs) that use the internet. Using techniques such as encryption and internet security aim to defend the transfer of data from attacks like malware and phishing as well as denial-of-service (DoS) attacks. Mobile security is the protection of portable devices, such as smartphones, tablets and laptops. Mobile security, also known as wireless security, secures the devices and the networks they connect to in order to prevent theft, data leakage and malware attacks. Network security is the protection of a network infrastructure and the devices connected to it through technologies, policies and practices. Network security defends against threats such as unauthorized access, and malicious use and modifications. Cybersecurity is the body of technologies, processes and practices designed to protect networks, computers, programs and data from attack, damage or unauthorized access. In a computing context, security includes both cybersecurity and physical security. One of the most problematic elements of cybersecurity is the quickly and constantly evolving nature of security risks. The traditional approach has been to focus most resources on the most crucial system components and protect against the biggest known threats, which necessitated leaving some less important system components undefended and some less dangerous risks not protected against. Such an approach is insufficient in the current environment.

SmartSecurity is a system and an application that revolutionizes the sharing and identification of content ownership, as well as the network identification and behavior of all interacting and communicating nodes and individuals. SmartSecurity incorporates an API that enables a complete integration of a hashed and digital signatures, supporting arbitrary applications, devices, operating systems and network configuration, and including synchronous and or asynchronous communication. Transactional (e.g., application, communication, and networks) data and information are encrypted and authorized with varying security level through the use of SmartSearch (U.S. Application No. 62/586,158 filed on Nov. 14, 2017 entitled Personalized All Media Search, which is hereby incorporated by reference) and SmartPlatform (U.S. Application No. 62/518,189 filed on Jun. 12, 2017, entitled SmartPlatform, which is hereby incorporated by reference). Encryption of hierarchical data within consumable all-media content can be invisible to the observer (e.g., watermarking) or it can be used to encrypt and allow/deny consumption, forwarding, or storing of any content, data and or information. Each user has a unique public-private key combined with their SmartData profile which is used to monitor the communication and consumption of data, information, content, and communications within an immutable table that is stored within super-nodes (U.S. Application No. 62/576,619 filed on Oct. 24, 2017, entitled CROSSMEDIA, which is hereby incorporated by reference) and SmartData processing servers. Unique behavioral user attributed, within a heterogeneous communication and content distribution network, is calculated by SmartSearch and is used to determine adversarial activities within an application to communication frameworks. Each SmartSecurity node communicates within a peer-to-peer, peer-to-super-node and peer-to-server using a network and Gossip protocols, and can also supporting a simple security scripting stack. SmartSecurity represents a completely new paradigm securing the internet, applications, and users.

Illustratively, the techniques described herein may be performed by hardware, software, and/or firmware. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

While there have been shown and described illustrative embodiments that provide for enhancing advertisements sent to users based on location, it is to be understood that various other adaptations and modifications may be made within the spirit and scope of the embodiments herein. For example, the embodiments have been shown and described herein with relation to user's personal device. However, the embodiments in their broader sense are not as limited.

The foregoing description has been directed to specific embodiments. It will be apparent; however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A system, comprising
a processor configured with an application interface to create hashed and digital signatures for a plurality of users and to assign each hashed and digital signatures to a user as a unique public-private key;
a memory configured to store a smart data profile with each user, wherein the smart data profile is used to monitor communication and consumption of data, information, content, or communication with super-nodes; and
a network interface configured to use the public-private key to receive and send data to securely communicate peer-to-peer, peer-to-super-node, or peer-to-server using network or gossip protocols.

2. The system of claim 1, wherein the processor is further configured to securely search using the public-private key associated with the user.

3. The system of claim 2, wherein the processor is further configured to use unique behavioral user attributes is calculated by a smart search module to determine adversarial activities.

4. The system of claim 1, wherein the public-private key is used in synchronous or asynchronous communication.

5. The system of claim 1, wherein the smart data is a real a real-time processing algorithm that creates deterministic views of each user.

6. The system of claim 1, wherein a unique behavioral user attributed, within a heterogeneous communication and a content distribution network, is calculated by a smart search algorithm and is used to determine adversarial activities within an application to communication frameworks.

7. The system of claim 1, further comprising one or more smart security nodes, wherein in each smart security node communicates peer-to-peer, peer-to-super-node and peer-to-server using network, Gossip protocols, or a simple security scripting stack.

8. The system of claim 1, wherein the unique public-private key includes encryption of hierarchical data within consumable substantially all media content.

9. The system of claim 8, wherein the encryption is invisible to the user.

10. The system of claim 1, wherein the unique public-private key enables complete integration of a hashed and digital signature supporting arbitrary applications, devices, operating systems and network configuration, and including synchronous and or asynchronous communication.

11. A method, comprising:
creating hashed and digital signatures for a plurality of users;
assigning each hashed and digital signature to a user as a unique public-private key;
storing a smart data profile with each user, wherein the smart data profile is used to monitor communication and consumption of data, information, content, or communication with super-nodes; and
sending data with the public-private key to securely communicate peer-to-peer, peer-to-super-node, or peer-to-server using network or gossip protocols.
